(19) United States
(12) Patent Application Publication
(10) Pub. No.: US 2019/0161007 A1
(43) Pub. Date: May 30, 2019

(54) UNILLUMINATED VEHICLE INDICATION BASED ON COMMUNICATION

(71) Applicant: GM Global Technology Operations LLC, Detroit, MI (US)

(72) Inventors: Vivek Vijaya Kumar, Shelby Township, MI (US); Hariharan Krishnan, Troy, MI (US); Mohammad Naserian, Windsor (CA); Allan K. Lewis, Windsor (CA)

(21) Appl. No.: 15/825,756

(22) Filed: Nov. 29, 2017

(51) Int. Cl. B60R 1/00; G06K 9/62; G06T 7/70; G06K 9/00

(52) U.S. Cl. CPC B60R 1/00; G06K 9/6202; B60R 2300/80; G06K 9/00825; G06T 7/70

(57) ABSTRACT

A system and method to perform unilluminated vehicle indication based on communication from a vehicle include communicating with one or more other vehicles within a communication range of the vehicle to obtain information from each of the one or more other vehicles. The method also includes obtaining images of one or more of the one or more other vehicles with one or more cameras of the vehicle, and matching the images with the information. A display is provided to a driver of the vehicle of some or all of the one or more of the one or more other vehicles.

### INTRODUCTION

The subject disclosure relates to unilluminated vehicle indication based on communication.

In low-light conditions, operators of vehicles (e.g., automobiles, trucks, motorcycles, constructions equipment) are generally aided by headlights. Illuminating a vehicle's headlights not only facilitates better visibility for that vehicle's operator but also makes that vehicle more visible to the operators of other vehicles in the vicinity. However, one or more vehicles may be unilluminated (i.e., headlights are not on) because of a malfunction in the headlights or because the vehicle operator forgot to turn on the headlights. In this case, the unilluminated vehicle is more difficult to see and, thus, creates a potential hazard for other vehicles in the area. Accordingly, it is desirable to provide an unilluminated vehicle indication based on communication.

### SUMMARY

In one exemplary embodiment, a method of performing unilluminated vehicle indication based on communication from a vehicle includes communicating with one or more other vehicles within a communication range of the vehicle to obtain information from each of the one or more other vehicles. The method also includes obtaining images of one or more of the one or more other vehicles with one or more cameras of the vehicle, and matching the images with the information. A display is provided to a driver of the vehicle of some or all of the one or more of the one or more other vehicles.

In addition to one or more of the features described herein, obtaining the information includes obtaining a location of each of the one or more other vehicles.

In addition to one or more of the features described herein, the obtaining the images with the one or more cameras includes obtaining the images from a rear or side of the vehicle.

In addition to one or more of the features described herein, the obtaining the images of the one or more of the one or more other vehicles includes obtaining the images of the one or more of the one or more other vehicles that are beside or behind the vehicle.

In addition to one or more of the features described herein, obtaining the information includes obtaining an indication of headlight operational status for each of the one or more other vehicles.

In addition to one or more of the features described herein, the method also includes performing image processing of the images obtained with the one or more cameras.

In addition to one or more of the features described herein, the performing the image processing indicates headlight operational status for each of the one or more of the one or more other vehicles.

In addition to one or more of the features described herein, the matching the images with the information includes determining a location and headlight operational status of each of the one or more of the one or more other vehicles in the images.

In addition to one or more of the features described herein, the providing the display is on a console of an infotainment system of the vehicle.

In addition to one or more of the features described herein, the providing the display is as a full display mirror on a rearview mirror or driver side mirror of the vehicle.

In another exemplary embodiment, a system to perform unilluminated vehicle indication based on communication from a vehicle includes a communication device to communicate with one or more other vehicles within a communication range of the vehicle to obtain information from each of the one or more other vehicles. The system also includes a controller to obtain images of one or more of the one or more other vehicles from one or more cameras, match the images with the information, and provide a display to a driver of the vehicle of some or all of the one or more of the one or more other vehicles.

In addition to one or more of the features described herein, the information includes a location of each of the one or more other vehicles.

In addition to one or more of the features described herein, the one or more cameras are located at a rear or side of the vehicle.

In addition to one or more of the features described herein, the one or more of the one or more other vehicles are beside or behind the vehicle.

In addition to one or more of the features described herein, the information includes an indication of headlight operational status for each of the one or more other vehicles.

In addition to one or more of the features described herein, the controller performs image processing of the images obtained with the one or more cameras.

In addition to one or more of the features described herein, the controller performing the image processing indicates headlight operational status for each of the one or more of the one or more other vehicles.

In addition to one or more of the features described herein, the controller matching the images with the information includes determining a location and headlight operational status of each of the one or more of the one or more other vehicles in the images.

In addition to one or more of the features described herein, the display is on a console of an infotainment system of the vehicle.

In addition to one or more of the features described herein, the display is as a full display mirror on a rearview mirror or driver side mirror of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a system to provide unilluminated vehicle indication according to one or more embodiments;

FIG. 2 illustrates an exemplary scenario for unilluminated vehicle indication based on communication according to one or more embodiments;

FIG. 3 is a process flow of a method of performing unilluminated vehicle indication based on communication according to one or more embodiments;

FIG. 4 shows a display that may be shown on the driver display indicated in FIG. 1; and

FIG. 5 shows a display that may be shown on the rearview mirror in lieu of the reflection in the rearview mirror according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, an unilluminated vehicle (i.e., a vehicle whose headlights are not operating) in low-light conditions can present a hazard by being less visible to operators of other vehicles in its vicinity. Communication among vehicles (i.e., V2V communication) is increasingly available. Embodiments of the systems and methods detailed herein relate to an unilluminated vehicle indication based on communication such as, for example, V2V communication. The V2V communication is used to identify other vehicles in a camera field of view (FOV). Low-light conditions are identified based on the vehicle's own systems. The illumination state of the other vehicles (i.e., whether their headlights are on or not) may be determined using image processing such that unilluminated vehicles may be highlighted in an image displayed to the driver or, according to alternate or additional embodiments, all vehicles identified via the V2V communication may be indicated in the image.

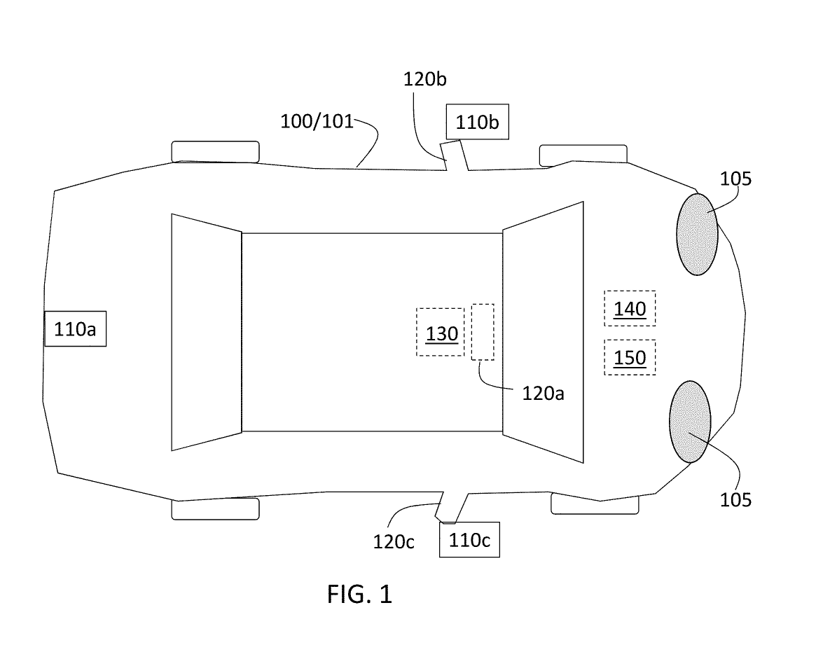

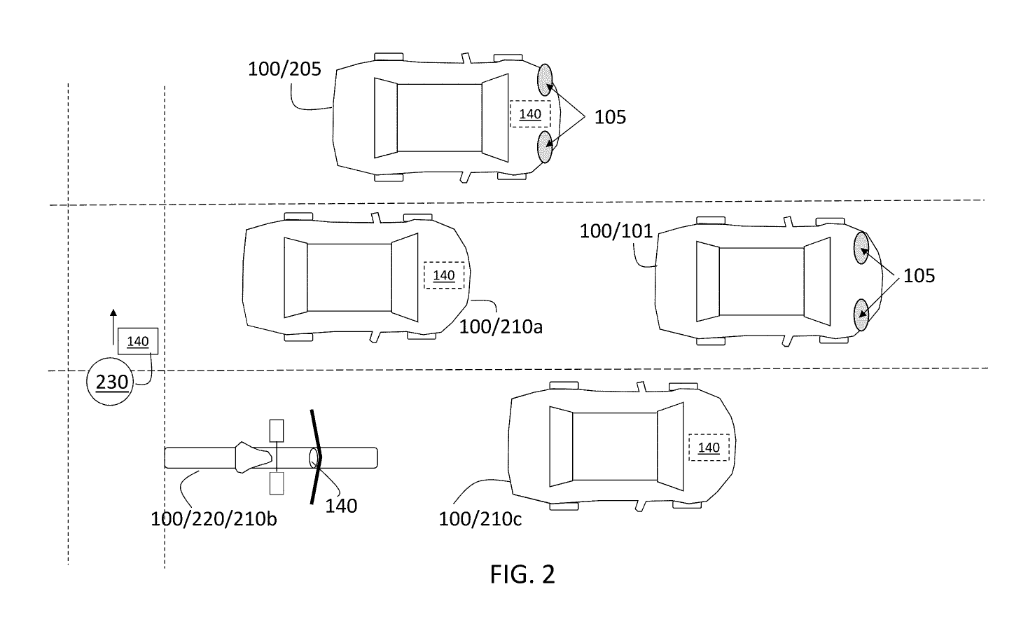

In accordance with an exemplary embodiment, FIG. 1 is a block diagram of a system to provide unilluminated vehicle 210 (FIG. 2) indication. The vehicle 100 shown in FIG. 1 is an automobile 101. The vehicle 100 is shown with illuminated headlights 105 in FIG. 1. The vehicle 100 is shown with exemplary cameras 110a, 110b, 110c (generally referred to as 110). The vehicle 100 also includes a rearview mirror 120a, a driver side mirror 120b, and a passenger side mirror 120c (generally referred to as 120). A driver display 130 in the vehicle 100 cabin may display controls of the infotainment system, climate controls, navigation, and alert messages.

A communication device 140 represents one or more known radio access technologies (RATs) such as those that provide access to WiFi, cellular, or Bluetooth, for example. The communication device 140 performs V2V communication and may additionally perform other V2X (i.e., vehicle-to-everything) communication such as vehicle-to-infrastructure (V2I) communication or vehicle-to-pedestrian (V2P) communication with pedestrians and cyclists who carry their own communication devices 140. The V2X communication among the various communication devices 140 may be via a dedicated short range communication (DSRC) standard. The DSRC standard is similar to WiFi, but operates on a dedicated frequency band and is optimized for low latency and mobility scenarios. Generally, any known messaging standards and structures may be used for the communication. For example, V2V communication may provide the latitude, longitude, elevation, speed, yaw, and heading of the vehicle 100 that is sending the message such that other vehicles 100 that receive the message know its location.

According to one or more embodiments, an image from one of the cameras 110 may be displayed on one of the mirrors 120 or the driver display 130, as detailed. A controller 150 of the vehicle may process the images from one or more cameras 110 to augment the displayed image. For example, the controller 150 may highlight an unilluminated vehicle 210 in the image by displaying a box around the unilluminated vehicle 210. Relative distances may additionally be indicated for the vehicles 100 displayed in the image. The controller 150 may be part of or may be coupled to the electronic control unit (ECU) of the vehicle 100. The controller 150 may also be coupled to sensors (e.g., radar, lidar), vehicle systems (e.g., collision avoidance, adaptive cruise control), and communication systems of the vehicle 100. The controller 140 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The processing circuitry facilitates the functionality detailed for the controller 150.

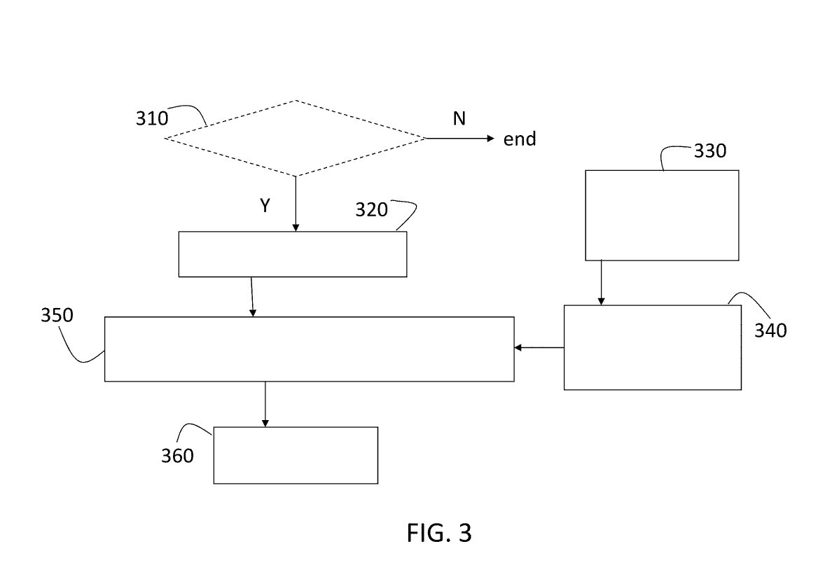

For explanatory purposes, the controller 150 is discussed as performing the various operations necessary for the unilluminated vehicle 210 indication based on communication according to one or more embodiments. However, the ECU or other controllers of the vehicle 100 may alternately or additionally perform the operations, which are generally outlined below and detailed further with reference to FIGS. 2 and 3.

One of the operations is detection of low-light conditions. For example, the controller 150 may determine low-light conditions based on photosensors used by the automatic headlight system or on the setting of the headlights. This operation may be optional, because the driver may want an augmented image of other vehicles 100 under all lighting conditions. Another operation is the detection of vehicles 100, which is done based on V2V communication. For example, a motorcycle 220 (FIG. 2) is a vehicle 100 that may include a communication device 140 that facilitates detection of the position of the motorcycle 220 in the vicinity of the vehicle 100. Yet another operation is the identification of unilluminated vehicles 210. Finally, the operation of displaying the unilluminated vehicles 210, according to one or more embodiments, provides information to the driver to aid in lane changes and other driving maneuvers.

FIG. 2 illustrates an exemplary scenario for unilluminated vehicle 210 indication based on communication according to one or more embodiments. The vehicle 100, which is the automobile 101 detailed in FIG. 1 and which includes an indication of unilluminated vehicles 210, is shown with illuminated headlights 105. Another vehicle 100 in the FOV of one or more cameras 110 of the automobile 101 is an illuminated vehicle 205 with illuminated headlights 105, as shown in FIG. 2. Two vehicles 100 and one motorcycle 220 are unilluminated vehicles 210a, 210b, 210c (generally referred to as 210) in the FOV of cameras 110 of the automobile 101. As FIG. 2 illustrates, a lane change to the right by the automobile 101 may result in a collision with the unilluminated vehicle 210c. Thus, indication of this and the other unilluminated vehicles 210 to the driver of the automobile 101 may increase safety. As FIG. 2 indicates, a pedestrian 230 is also in the FOV of cameras 110 of the automobile 101. The pedestrian is shown carrying a communication device 140 such that the pedestrian may perform V2P communication with the automobile 101. The exemplary pedestrian 230 is moving across the FOV of the cameras 110 and is not travelling in the same direction as the automobile 101.

FIG. 3 is a process flow of a method of performing unilluminated vehicle indication based on communication according to one or more embodiments. At block 310, a check is done of whether there is a low-light condition. As indicted, this process is optional, because a driver may choose to have an augmented display of vehicles 100 in the FOV of the automobile 101 cameras 110 regardless of the lighting conditions. Whether the low-light condition exists or if the process at block 310 is omitted, performing communication, at block 320, refers to performing V2V communication and V2P communication with objects that are within communication range of the automobile 101. For example, communication range using DSRC may be on the order of 800 meters. The communication may help to identify unilluminated vehicles 210. For example, a V2V message broadcast by a vehicle 100 may indicate that it is an unilluminated vehicle 210 due to a malfunction, for example. As previously noted, communication messages indicate the specific location and, thus, indicate relative location of each vehicle 100 or other object (e.g., pedestrian 230, cyclist) that broadcasts a message within communication range of the automobile 101.

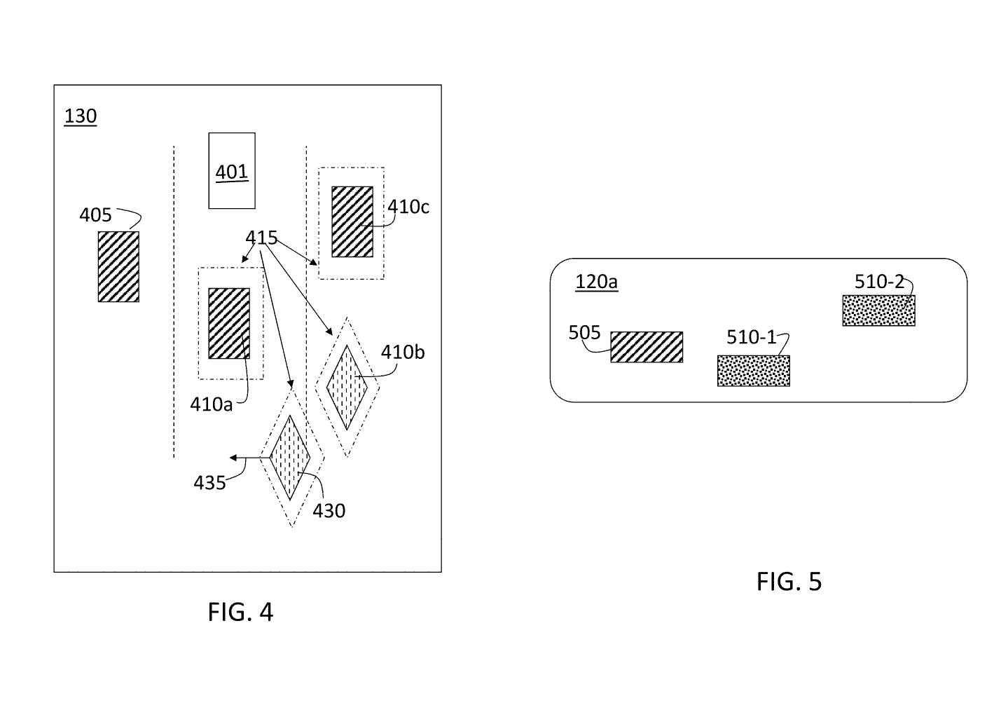

At block 330, the processes include obtaining images with one or more cameras 110 of the automobile 101. As indicated in FIG. 1, the cameras 110 may be located to augment the reflections provided by the rearview and side mirrors 120. For example, camera 110a obtains images behind the automobile 101 without any obstructions (e.g., rear-seat passengers) reflected in the rearview mirror 120a. Obtaining the images, at block 330, is followed by performing image processing, at block 340. Performing image processing may be used to identify unilluminated vehicles 210, for example. At block 350, matching camera images with communication refers to matching each vehicle 100 or other object captured by the cameras 110 with information (e.g., location) obtained via the V2V or V2P communication. That is, at least the location and headlight operational status (i.e., illuminated or unilluminated) may be known for each vehicle 100 or other object captured by the cameras 110. Providing the display, at block 360, based on the matching, at block 350, is further discussed with reference to FIGS. 4 and 5.

FIGS. 4 and 5 depict two different exemplary displays obtained according to one or more embodiments. FIG. 4 shows a display that may be shown on the driver display 130, indicated in FIG. 1. This display shows coded objects that indicate the objects shown in the exemplary scenario of FIG. 2. The automobile 101 is shown as representation 401. The illuminated vehicle 205 is shown as representation 405, and the unilluminated vehicles 210a, 210b, and 210c are shown as representations 410a, 410b, 410c (generally referred to as 410). The pedestrian 230 is shown as representation 430 with the direction of travel 435 indicated.

The pattern of the objects in FIG. 4 indicates their relative distance to the automobile 101. That is, in the exemplary display shown in FIG. 4, the closest vehicle 100 in each lane is indicated with the same pattern. According to alternate embodiments, all vehicles 100 within a threshold distance to the automobile 101 may be indicated with the same pattern, color, or other indicator. As FIG. 4 also indicates, representations 410 of unilluminated vehicles 210 are indicated with a box 415. The box 415 is also used to show the representation 430 of the pedestrian 230 as an unilluminated object. Based on driver selection or according to alternate embodiments, the pedestrian 230 may not be represented at all. That is, only objects travelling in the same direction as the automobile 101 may be shown in the display. In low-light conditions, the driver of the automobile 101 may not be able to see unilluminated vehicle 210c. However, as FIG. 4 makes clear, the position of the unilluminated vehicle 210c, shown as representation 410c, provides a clear indication to the driver that a lane change to the right is not advised, for example.

FIG. 5 shows a display that may be shown on the rearview mirror 120a in lieu of the reflection in the rearview mirror 120a, for example. This is referred to as a full display mirror (FDM). In the exemplary display shown in FIG. 5, only the closest vehicles 100, illuminated vehicle 205 and unilluminated vehicles 210a, 210c, which are represented, respectively, as representations 505, 510-1, 510-2, as displayed. The position of the representations 505, 510-1, 510-2 may match the positions of their reflections in the rearview mirror 120a, for example. The unilluminated vehicles 210a, 201c may be shown as representations 510-1, 510-2 with a different pattern than the representation 505 of the illuminate vehicle 205.

As previously noted, FIGS. 4 and 5 are only exemplary displays. Many variations and additions of these displays are contemplated. For example, the driver side mirror 120b may be used as a FDM in addition to or instead of the rearview mirror 120a. The automobile 101 may use cameras 110b, 110c and corresponding images on the driver display 130 in lieu of having the driver side mirror 120b and passenger side mirror 120c at all. According to some embodiments, only unilluminated vehicles 210 may be shown at all. No box 415 or other form of highlighting the unilluminated vehicles 210 would be needed in this case. According to other embodiments, all vehicles 100 and objects may be shown without any distinction between illuminated and unilluminated objects. Further, the images themselves may be displayed rather than representations of the objects.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of performing unilluminated vehicle indication based on communication from a vehicle, the method comprising:
communicating with one or more other vehicles within a communication range of the vehicle to obtain information from each of the one or more other vehicles;
obtaining images of one or more of the one or more other vehicles with one or more cameras of the vehicle;
matching the images with the information; and
providing a display to a driver of the vehicle of some or all of the one or more of the one or more other vehicles.

2. The method according to claim 1, wherein obtaining the information includes obtaining a location of each of the one or more other vehicles.

3. The method according to claim 1, wherein the obtaining the images with the one or more cameras includes obtaining the images from a rear or side of the vehicle.

4. The method according to claim 3, wherein the obtaining the images of the one or more of the one or more other vehicles includes obtaining the images of the one or more of the one or more other vehicles that are beside or behind the vehicle.

5. The method according to claim 1, wherein obtaining the information includes obtaining an indication of headlight operational status for each of the one or more other vehicles.

6. The method according to claim 1, further comprising performing image processing of the images obtained with the one or more cameras.

7. The method according to claim 6, wherein the performing the image processing indicates headlight operational status for each of the one or more of the one or more other vehicles.

8. The method according to claim 1, wherein the matching the images with the information includes determining a location and headlight operational status of each of the one or more of the one or more other vehicles in the images.

9. The method according to claim 1, wherein the providing the display is on a console of an infotainment system of the vehicle.

10. The method according to claim 1, wherein the providing the display is as a full display mirror on a rearview mirror or driver side mirror of the vehicle.

11. A system to perform unilluminated vehicle indication based on communication from a vehicle, the system comprising:
a communication device configured to communicate with one or more other vehicles within a communication range of the vehicle to obtain information from each of the one or more other vehicles; and
a controller configured to obtain images of one or more of the one or more other vehicles from one or more cameras, match the images with the information, and provide a display to a driver of the vehicle of some or all of the one or more of the one or more other vehicles.

12. The system according to claim 11, wherein the information includes a location of each of the one or more other vehicles.

13. The system according to claim 11, wherein the one or more cameras are located at a rear or side of the vehicle.

14. The system according to claim 13, wherein the one or more of the one or more other vehicles are beside or behind the vehicle.

15. The system according to claim 11, wherein the information includes an indication of headlight operational status for each of the one or more other vehicles.

16. The system according to claim 11, wherein the controller is further configured to perform image processing of the images obtained with the one or more cameras.

17. The system according to claim 16, wherein the controller performing the image processing indicates headlight operational status for each of the one or more of the one or more other vehicles.

18. The system according to claim 11, wherein the controller matching the images with the information includes determining a location and headlight operational status of each of the one or more of the one or more other vehicles in the images.

19. The system according to claim 11, wherein the display is on a console of an infotainment system of the vehicle.

20. The system according to claim 11, wherein the display is as a full display mirror on a rearview mirror or driver side mirror of the vehicle.
